(19) United States
(12) Patent Application Publication
(10) Pub. No.: US 2008/0023542 A1
(43) Pub. Date: Jan. 31, 2008

(54) METHOD AND SYSTEM FOR ACCRUAL TRANSACTION PROCESSING IN LOYALTY PROGRAMS

(75) Inventors: Nandan KAMAT, Hyderabad (IN); Yogendra Joshi, Hyderabad (IN); Ritabrata Bhattacharyya, Kolkata (IN); Rajmohan Nair, Hyderabad (IN); Sreenivasa Hosamane, Hyderabad (IN)

Correspondence Address: EVERGREEN VALLEY LAW GROUP, P.C. AND;ORACLE INTERNATIONAL CORPORATION, 2670 SOUTH WHITE ROAD, SUITE 275, SAN JOSE, CA, 95148, US

(73) Assignee: ORACLE INTERNATIONAL CORPORATION, REDWOOD SHORES, CA (US)

(21) Appl. No.: 11/463,889

(22) Filed: Aug. 10, 2006

(30) Foreign Application Priority Data
Jul. 27, 2006 (IN) 1313/CHF/2006

(51) Int. Cl. G06K 5/00; G06Q 30/00

(52) U.S. Cl. 235/380; 705/14

(57) ABSTRACT

The present invention discloses a method and system for accrual transaction processing in loyalty programs. The method according to the present invention includes the steps of setting up an accrual template, and validating accrual transactions received from loyalty partners against transaction attributes in the accrual template. The present invention imparts accrual transaction process an ability to accurately calculate rewards for loyalty member activities of different types undertaken with loyalty partners from diverse industries.

### BACKGROUND OF THE INVENTION

1. Field of the Invention

The present invention generally relates to a customer loyalty program and, in particular, to a method and system for creating a flexible accrual transaction framework in loyalty transactions.

2. Description of Related Art

Customer loyalty programs were introduced by airlines, hotels, and rental car companies to retain their existing customers as well as to attract new customers. In many of these programs, a customer earns loyalty units (generally regarded as points, miles, etc) for undertaking some activity (E.g. taking flights on host airline or a partner airline or a card partner). The loyalty units, which are earned in these programs, can be redeemed for various goods and services offered as awards. The principle of a loyalty program is to retain an existing customer base, as it is more expensive to bring in new customers than to retain existing ones.

Airline loyalty programs are broad-basing their partner network with a global and diverse spread to offer their existing members a broader choice of products and services. Loyalty programs have partnerships across industries such as airlines, hotels, car rental companies, credit card companies, telecommunications and real estate companies. This enhances the value proposition of the program encouraging prospects to be members of the loyalty program and drives revenue and profitability and most importantly innovation for the loyalty program.

Loyalty members undertake business transactions with these loyalty partners and loyalty partners in turn send the loyalty member activity reports to loyalty operation. Loyalty operation then processes these reports to calculate rewards in loyalty units to be credited to loyalty members. One of the prime imperatives for an accrual transaction process is to ensure that the loyalty member activity report contains all the necessary information, which is required to calculate accruals (for eligible purchases) and that the activities are not received or processed twice. These tasks are rendered very complex due to the fact that the contents of these activity reports often vary based on the loyalty partner with whom the activity is done and the nature of activity. The diversity, geographical spread and different levels of technological maturity of loyalty partners further pose operational challenges such as inability to standardize the data formats for activity reports received from them for accrual processing. For example, a loyalty member can engage with loyalty partners like an airline and a hotel, but the transaction attributes required to calculate rewards for loyalty members are different for airlines and hotels. For airlines, the transaction attributes may include origin airport, destination airport, flight date and flight number, whereas for hotel stay the same may be room type, location code, invoice number, check-in date and checkout date. So, there are no standardized data formats for member activity reports received from the loyalty partners. Also, to ensure that the activities are not processed twice, system needs to know which attributes of the loyalty member activity to check, in order to detect duplicates. This drastically varies from activity to activity. For example, in case of a flight activity, membership number, flight number, date of departure, origin airport uniquely identify an activity; In case of hotel stay, partner code, location number and bill number uniquely identify an activity. Hence these attributes can be used to detect duplicate transactions so as to prevent rewarding the member twice for the same activity.

Currently, loyalty programs lack such capabilities leading to operational inefficiencies and high maintenance cost. Hence, there exists a need for a flexible and scalable accrual transaction processing framework that is capable of processing any type of loyalty member activity performed with loyalty partners belonging to diverse industries.

### SUMMARY OF THE INVENTION

In order to overcome the deficiencies of the prior art there is provided a method and a system, which allows loyalty program to setup a configurable accrual template for each partner-product combination. The method of the present invention allows loyalty program to select the transaction attributes to be checked for mandatory and duplicate validations as relevant for the partner-product combination. While processing a loyalty member activity, accrual transaction process carries out the data validations for accrual transactions (Partner Accrual Records or PARs) representing member activities, based on the accrual template.

In an embodiment of the present invention, a method for accrual transaction processing in a loyalty program is provided. The method includes the steps of setting up an accrual template and validating accrual transactions received from a plurality of loyalty partners against the accrual template. Setting up the accrual template further includes creating the accrual template, selecting mandatory attributes and a set of attributes for checking the existence of duplicate transactions (duplicate attributes) for performing a mandatory check and duplicate check respectively and associating the accrual template to a partner-product combination, effective within a stated timeframe. Validating accrual transactions received from the loyalty partners further includes identifying the accrual template associated to the partner-product combination, performing the check for mandatory attributes in the accrual transaction and performing the check for duplicate transactions.

In another embodiment of the present invention, a system is provided for accrual transaction processing in a loyalty program. The system includes a setup module for setting up an accrual template and a validation module for validating accrual transactions received from loyalty partners against the transaction attributes in the accrual template. The setup module includes a user interface for creating the accrual template and selecting the transaction attributes for performing a mandatory check and duplicate check, and a linking module for linking the accrual template to a partner-product combination, effective within a stated timeframe. The validation module further includes an accrual record receiver for receiving accrual transactions from the loyalty partners, an accrual template identifier to identify the accrual template associated to the partner-product combination, a mandatory checking module for performing mandatory check, and a duplicate checking module for performing duplicate check. The mandatory check is performed for verifying the mandatory attributes in the accrual transactions as specified in the accrual template. The duplicate check is performed for verifying the duplicate transactions by comparing the incoming accrual transactions with member's transaction history, using the attributes in the accrual transactions as specified in the accrual template.

The above summary of the present invention is not intended to describe each disclosed embodiment of the present invention. The figures and detailed description that follow provide additional aspects of the present invention.

### BRIEF DESCRIPTION OF DRAWINGS

The invention may be more completely understood in consideration of the following detailed description of various embodiments of the invention in connection with the accompanying drawings, in which:

FIG. 1 is a flow diagram illustrating an embodiment of the method of setting up an accrual template in loyalty transaction processing.

FIG. 2 is a flow diagram illustrating an embodiment of the method of accrual validation process in loyalty transaction processing.

FIG. 3 is a block diagram illustrating components of the system for accrual transaction processing according to an embodiment of the present invention.

### DETAILED DESCRIPTION OF DRAWINGS

In the following description, numerous specific details are set forth in order to provide a more thorough understanding of the present invention. However, it will be apparent to one skilled in the art that the present invention may be practiced without these specific details. In other instances, well-known features have not been described in detail in order to avoid obscuring the present invention.

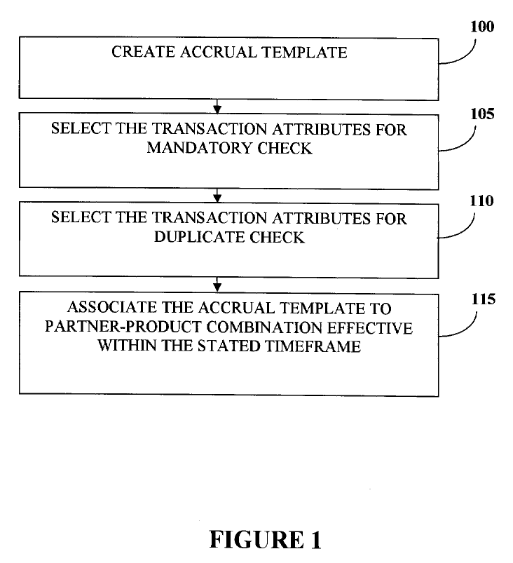

FIG. 1 is a flow diagram illustrating an embodiment of the method of setting up an accrual template in loyalty transaction processing. The method of the present invention enables the loyalty members to setup a configurable accrual template for each partner-product combination. Setting up of the accrual template is explained as follows. Loyalty program administrator logs in to the loyalty system and creates an accrual template 100. Transaction attributes are selected for mandatory check and duplicate check respectively 105, 110. Mandatory attributes include the transaction attributes selected according to the agreement between the loyalty program and its partners. The following examples explain mandatory attributes required for accrual transaction processing for a flight activity, hotel stay activity and real estate activity respectively. For a flight activity, the mandatory attributes include origin airport, destination airport, flight date, operating carrier and flight number. These attributes are mandatory for accrual transaction processing. For a hotel stay, mandatory attributes include room type, location code, invoice number, check-in date, checkout date, amount and so on.

Duplicate attributes include the transaction attributes, which are checked for existence of duplicate transactions in member transaction history. For example, the transaction attributes, which are relevant to check an airline activity for duplicates may typically be date of departure and flight number, while in case of credit card transaction activity; it may be just the transaction number. This would be so considering the fact that a loyalty member cannot fly twice on the same day on the same flight number; however, the loyalty member can undertake several credit card transactions on the same day. The accrual template is associated with a partner-product combination effective within a stated timeframe 115. While processing the loyalty member activity received from the loyalty partner, accrual transaction processing performs the data validations based on the accrual template associated to a partner for the given product.

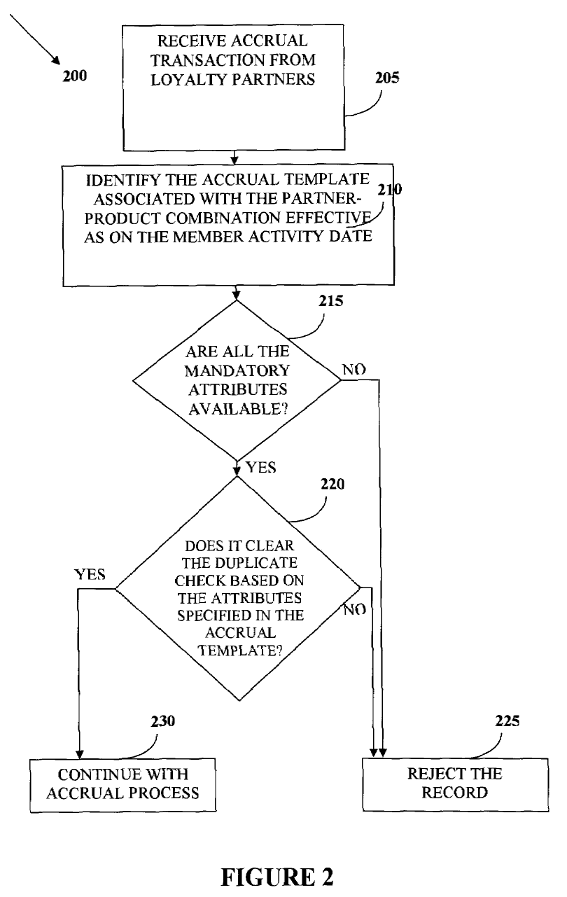

FIG. 2 is a flow diagram illustrating an embodiment of the method of accrual validation process in loyalty transaction processing 200. The accrual validation process validates accrual transactions received from loyalty partners against the transaction attributes in the accrual template. Loyalty system receives accrual transactions sent by the loyalty partners 205, and identifies the accrual template associated with a partner-product combination effective as on the date of member activity 210. Loyalty system checks if all the mandatory attributes as specified in the accrual template are available in the accrual transaction 215. If all the mandatory attributes are available in the accrual transaction, the loyalty system checks for the existence of duplicate transaction in member transaction history based on the transaction attributes specified in the accrual template to be used to check for duplicates 220. If the duplicate transaction is not found, the loyalty system continues with the accrual transaction processing 230. If the duplicate transaction is found, the accrual transaction will be rejected 225.

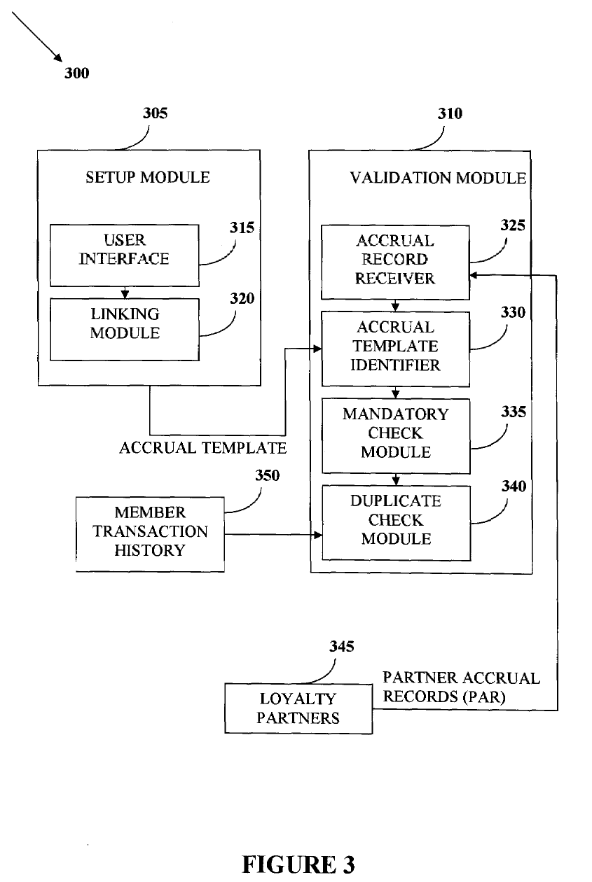

FIG. 3 is a block diagram illustrating components of the system for accrual transaction processing according to the embodiment of the present invention 300. The system includes a setup module 305, user interface 315, linking module 320, validation module 310, accrual transaction receiver 325, accrual template identifier 330 to identify accrual template, mandatory check module 335, and duplicate check module 340. The setup module 305 includes the user interface 315 and linking module 320. Loyalty administrator logs into system through the interactive user interface 315 and creates the accrual template. The transaction attributes are selected for performing a mandatory check and duplicate check respectively. Loyalty administrator is able to specify the mandatory attributes and duplicate attributes in the accrual template. The linking module 320 is provided for linking the accrual template to a partner-product combination effective within a stated timeframe.

The accrual record receiver 325 receives the accrual transactions sent by the loyalty partners 345 and the transaction processing identifies the accrual template to be used for validation. After receiving accrual transactions, the mandatory check module 335 performs a mandatory check. The mandatory check is performed to verify if all the mandatory attributes as specified in the accrual template are available in the accrual transactions. If the mandatory check is successful, duplicate check module 340 performs a duplicate check to ensure that the accrual transactions are not processed twice. Duplicate check module 340 checks for the existence of duplicate transactions in the member's transaction history 350 of the loyalty system.

The method and system according to the present invention finds its application in customer loyalty programs for calculating rewards for loyalty member activities of different types undertaken with loyalty partners from diverse industries.

1. A method for accrual transaction processing in a loyalty program comprising the steps of:
setting up an accrual template, wherein said accrual template comprises a plurality of transaction attributes setup by a loyalty administrator in said loyalty program; and
validating a set of accrual transactions received from a plurality of loyalty partners against said transaction attributes in the accrual template.

2. The method of claim 1, wherein the transaction attributes comprise a set of mandatory attributes and a set of attributes used for checking whether the duplicate transactions exist.

3. The method of claim 2, wherein said setting up the accrual template comprises: creating the accrual template by selecting said mandatory attributes for performing a mandatory check; creating the accrual template by selecting said set of attributes for performing a duplicate check; and associating the accrual template to a partner-product combination in accordance with a date effectivity.

4. The method of claim 3, wherein said creating the accrual template includes selecting mandatory attributes and set of attributes for checking duplicate transactions from the transaction attributes as relevant for said partner-product combination.

5. The method of claim 2, wherein the mandatory attributes include the transaction attributes selected according to a set of respective agreements between the loyalty program and said plurality of loyalty partners.

6. The method of claim 2, wherein the set of attributes for duplicate check include the transaction attributes which are checked for existence of duplicate transaction in member transaction history.

7. The method of claim 1, wherein said validating accrual records comprises:
receiving said accrual transactions from the plurality of loyalty partners;
identifying the accrual template associated with a partner-product combination;
performing a mandatory check for verifying mandatory attributes in the accrual transactions as specified in the accrual template; and
performing a duplicate check for existence of duplicate transaction in member transaction history.

8. The method of claim 7, wherein the accrual transactions from the plurality of partners are rejected if the mandatory attributes are not available.

9. The method of claim 7, wherein the duplicate check is performed if the mandatory check is successful.

10. The method of claim 1, wherein the plurality of loyalty partners belong to diverse industries.

11. A system for accrual transaction processing in a loyalty program comprising:
a setup module for setting up an accrual template, wherein said accrual template comprises a plurality of transaction attributes setup by loyalty administrator in said loyalty program; and
a validation module for validating a set of accrual transactions received from a plurality of loyalty partners against said transaction attributes in the accrual template.

12. The system as in claim 11, wherein the transaction attributes comprise a set of mandatory attributes and attributes for checking existence of duplicate transaction.

13. The system as in claim 11, wherein said setup module comprises:
a user interface for creating the accrual template and selecting the transaction attributes for performing a mandatory check and duplicate check; and
a linking module for linking the accrual template to a partner-product combination effective within a stated timeframe.

14. The system as in claim 11, wherein said validation module comprises:
an accrual transaction receiver for receiving said accrual transactions from said plurality of loyalty partners;
an accrual template identifier for identifying the accrual template associated to the partner-product combination from the setup module;
a mandatory checking module for performing a mandatory check for verifying availability of mandatory attributes in the accrual transactions as specified in the accrual template; and
a duplicate checking module for checking the existence of duplicate transactions in the member transaction history based on the transaction attributes specified in the accrual template for duplicate check.

15. The system as in claim 12, wherein the mandatory attributes include the transaction attributes selected according to a set of respective agreements between the loyalty program and the plurality of loyalty partners.

16. The system as in claim 12, wherein the duplicate attributes include the transaction attributes which are checked for existence of duplicate transaction in member transaction history.

17. The system as in claim 11, wherein the plurality of loyalty partners belong to diverse industries.
